(19) United States
(12) Patent Application Publication
(10) Pub. No.: US 2015/0166825 A1
(43) Pub. Date: Jun. 18, 2015

(54) TOUGHENED EPOXY RESIN FORMULATIONS

(71) Applicant: Dow Global Technologies LLC, Midland, MI (US)

(72) Inventors: James P. Godschalx, Midland, MI (US); Lameck Banda, Manvel, TX (US); David A. Reuschle, Lake Jackson, TX (US)

(21) Appl. No.: 14/416,535

(22) PCT Filed: Nov. 1, 2012
(86) PCT No.: PCT/US12/62938

§ 371 Date: Jan. 22, 2015

Related U.S. Application Data
(60) Provisional application No. 61/698,087, filed on Sep. 7, 2012.

(51) Int. Cl. C09D 163/00; C09J 163/00; C09D 151/00; C09J 151/00; C08L 51/00; C08L 63/00

(52) U.S. Cl. CPC C09D 163/00; C08L 51/003; C08L 63/00; C09D 151/003; C09J 151/003; C09J 163/00; C08L 2207/53

(57) ABSTRACT

A composition comprising: an epoxy resin, a curing agent; and a bimodal core shell rubber comprising a styrene butadiene core and a styrene-acrylonitrile shell is disclosed. The composition can then be used to make a varnish formulation.

### REFERENCE TO RELATED APPLICATIONS

The present application claims the benefit of U.S. Provisional Application No. 61/698,087, filed on Sep. 7, 2012.

### FIELD OF THE INVENTION

This invention is related to epoxy resins. More specifically, this invention is related to the use of epoxy resins in the manufacture of electrical laminates.

### BACKGROUND OF THE INVENTION

Epoxy resins are one of the most widely used engineering resins, and are well-known for their use in electrical laminates. Epoxy resins have been used as materials for electrical/electronic equipment, such as materials for electrical laminates because of their superiority in heat resistance, chemical resistance, insulation property, dimensional stability, and adhesion.

Due to the switch to lead free solders, epoxy resins used in the manufacture of electrical laminates have been modified to increase the glass transition temperature of the cured formulation to enable processing of the lead free solders at higher temperatures than solders containing lead. The higher glass transition temperature resins tend to be more brittle and show defects after hole drilling and/or edge routing. It would be desirable to identify toughening agents that could be added to the epoxy formulation to prevent the defects from forming while maintaining the other properties of the epoxy system such as processability, high glass transition temperature, dielectric constant, moisture uptake, copper peel strength, and coefficient of thermal expansion.

### SUMMARY OF THE INVENTION

In an embodiment of the present invention, there is disclosed a composition comprising, consisting of, or consisting essentially of: an epoxy resin, a curing agent, and a bimodal core shell rubber comprising a styrene butadiene core and a styrene-acrylonitrile shell.

### DETAILED DESCRIPTION

### Epoxy Resin

The epoxy resins used in embodiments disclosed herein may vary and include conventional and commercially available epoxy resins, which may be used alone or in combinations of two or more, including, for example, novolac resins, isocyanate modified epoxy resins, and carboxylate adducts, among others. In choosing epoxy resins for compositions disclosed herein, consideration should not only be given to properties of the final product, but also to viscosity and other properties that may influence the processing of the resin composition.

The epoxy resin component may be any type of epoxy resin useful in molding compositions, including any material containing one or more reactive oxirane groups, referred to herein as “epoxy groups” or “epoxy functionality.” Epoxy resins useful in embodiments disclosed herein may include mono-functional epoxy resins, multi- or poly-functional epoxy resins, and combinations thereof. Monomeric and polymeric epoxy resins may be aliphatic, cycloaliphatic, aromatic, or heterocyclic epoxy resins. In an embodiment, the epoxy resins include, but are not limited to glycidyl ethers, cycloaliphatic resins, epoxidized oils, and so forth Specific examples include the condensation products of bisphenol A diglycidyl ether with bisphenol A, tetrabromobisphenol A or the condensation products of the diglycidyl ether of tetrabromobisphenol A with bisphenol A or tetrabromobisphenol A. Commercial examples include, but are not limited to D.E.R.™ 592 and D.E.R.™ 593, each available from The Dow Chemical Company, Midland Mich. It is common to add the glycidyl ethers of novolacs, which are polyphenols derived from condensation of formaldehyde or other aldehyde with a phenol. Specific examples include the novolacs of phenol, cresol, dimethylphenols, p-hydroxybiphenyl, naphthol, and bromophenols.

Other commercial examples include D.E.R.™ 331 (bisphenol A liquid epoxy resin) and D.E.R.™ 332 (diglycidyl ether of bisphenol A), D.E.R.™ 592 (a flame retardant brominated epoxy resin), a flame retardant brominated bisphenol type epoxy resin available under the tradename D.E.R.™ 560, 1,4-butanediol diglycidyl ether of phenol formaldehyde novolac (such as those available under the tradenames D.E.N.™ 431 and D.E.N.™ 438. The D.E.N.™ and D.E.R.™ products are available from The Dow Chemical Company, Midland, Mich. Mixtures of any of the above-listed epoxy resins may also be used.

### Curing Agents

A hardener or curing agent may be provided for promoting crosslinking of the curable composition. The hardeners and curing agents may be used individually or as a mixture of two or more. In some embodiments, hardeners may include dicyandiamide (dicy) or phenolic curing agents such as novolacs, resoles, and bisphenols. Anhydrides such as poly(styrene-co-maleic anhydride) may also be used.

Curing agents may also include primary and secondary polyamines and adducts thereof, anhydrides, and polyamides. For example, polyfunctional amines may include aliphatic amine compounds such as diethylene triamine (D.E.H.™ 20, available from The Dow Chemical Company, Midland, Mich.), triethylene tetramine (D.E.H.™ 24, available from The Dow Chemical Company, Midland, Mich.), tetraethylene pentamine (D.E.H.™ 26, available from The Dow Chemical Company, Midland, Mich.), as well as adducts of the above amines with epoxy resins, diluents, or other amine-reactive compounds. Aromatic amines, such as metaphenylene diamine and diamine diphenyl sulfone, aliphatic polyamines, such as amino ethyl piperazine and polyethylene polyamine, and aromatic polyamines, such as metaphenylene diamine, diamino diphenyl sulfone, and diethyltoluene diamine, may also be used.

Anhydride curing agents may include, for example, nadic methyl anhydride, hexahydrophthalic anhydride, trimellitic anhydride, dodecenyl succinic anhydride, phthalic anhydride, methyl hexahydrophthalic anhydride, tetrahydrophthalic anhydride, and methyl tetrahydrophthalic anhydride, among others.

The hardener or curing agent may include a phenol-derived or substituted phenol-derived novolac or an anhydride. Non-limiting examples of suitable hardeners include phenol novolac hardener, cresol novolac hardener, dicyclopentadiene bisphenol hardener, limonene type hardener, anhydrides, and mixtures thereof.

In other embodiments, curing agents may include dicyandiamide, boron trifluoride monoethylamine, and diaminocyclohexane. Curing agents may also include imidazoles, their salts, and adducts. Other curing agents include phenolic, benzoxazine, aromatic amines, amido amines, aliphatic amines, anhydrides, and phenols.

### Core Shell Rubber

In an embodiment, the shell comprises at least 5 weight percent of the total weight of the core shell rubber. In another embodiment of the invention, the ratio of core/shell of the core shell rubber is 47/53.

Bimodal rubbers useful in embodiments of the present invention are generally prepared using a process described in U.S. Pat. No. 5,955,540. This process involves the conventional preparation of latex particles. There are many methods known in the art for the preparation of such particles. One example is preparing an initial aqueous emulsion of an elastomeric (i.e., rubbery) polymer in which the colloidally dispersed rubbery polymer particles contained therein are composed of an elastomeric conjugated diene polymer and have a volume average particle size of from 0.15 to 0.22 microns. Preferred initial aqueous elastomeric polymer emulsions for use herein are those which have a relatively narrow, monomodal particle size distribution and which have a volume average rubber particle size in the range of from 0.15 to 0.2 microns.

The latex particle preparation is followed by partial agglomeration (or clustering) to a rubber that disperses with a unique morphology. This causes from 5 to 50 weight percent of the dispersed polymer particles to agglomerate. In an embodiment, the agglomeration step is conducted in a fashion such that from 10 or 15 to 45 or 50 weight percent of the initial small-sized dispersed elastomeric polymer particles are converted to the indicated enlarged particle size elastomeric polymer constituent.

Suitable core-shell rubbers useful in embodiments of the present invention include, but are not limited to GRC 310, Kaneka core shell rubbers, Metablen core shell rubbers, and Kumho core shell rubbers.

In an embodiment of the invention, the grafted rubber concentrate is GRC-310. GRC-310 is a core-shell rubber particle synthesized by emulsion polymerization. The particle size distribution is bimodal with the larger particles having an average particle size of 0.6 μm. The smaller particles have an average particle size of 0.1 μm. The smaller particles constitute the larger component of the bimodal particle size distribution. A core shell rubber with bimodal morphology shows superior performance in fracture toughness improvement, compared with other core shell rubbers.

While not wishing to be bound by theory, it is believed that the small particle toughens the shear bands between large particles. On the other hand, the large particle induces a large-scale shear deformation in the crack front. It is this synergistic effect of these particles that is thought to be responsible for the observed superior fracture toughness performance in epoxy resins.

Additionally, bimodal rubber particle distributions can also give a lower dispersion viscosity at the same volume fraction as monodisperse spheres. Alternatively stated, the bimodal particles allow higher dispersion volume loadings at an equivalent viscosity to monodisperse spheres. These observations are attributed to improved particle packing over uni-modal particle size distributions.

Another significant aspect of the bimodal rubber is the unique local clustering morphology observed when dispersed in epoxy resins. It is thought that the local clustering of the toughener particles in the resin not only preserves the important rubber cavitation and matrix shear-yielding mechanisms, but also triggers a vigorous crack deflection mechanism. It is believed that the additional crack-deflection mechanism is probably the main reason for such a synergistic toughening effect. Thus the local clustering morphology of the bimodal rubber offers significant advantages over the random particle dispersion observed with the other core shell rubber type toughening particles.

In an embodiment, the composition comprises from 0.1 weight percent to 25 weight percent and from 0.1 weight percent to 30 weight percent styrene-acrylonitrile/styrene-butadiene core/shell rubber by weight, based on a total weight of the curable composition.

### Catalysts

Optionally, catalysts may be added to the curable compositions described above. Catalysts may include, but are not limited to, imidazole compounds including compounds having one imidazole ring per molecule, such as imidazole, 2-methylimidazole, 2-ethyl-4-methylimidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzylimidazole, 1-cyanoethyl-2-methylimidazole, 1-cyanoethyl-2-ethyl-4-methylimidazole, 1-cyanoethyl-2-undecylimidazole, 1-cyanoethyl-2-isopropylimidazole, 1-cyanoethyl-2-phenylimidazole, 2,4-diamino-6-[2′-methylimidazolyl-(1)′]-ethyl-s-triazine, 2,4-diamino-6-[2′-ethyl-4-methylimidazolyl-(1)′]-ethyl-s-triazine, 2,4-diamino-6- [2′-undecylimidazolyl-(1)′]-ethyl-s-triazine, 2-methyl-imidazo-lium-isocyanuric acid adduct, 2-phenylimidazolium-isocyanuric acid adduct, 1-aminoethyl-2-methylimidazole, 2-phenyl-4,5-dihydroxymethylimidazole, 2-phenyl-4-methyl-5-hydroxymethylimidazole, 2-phenyl-4-benzyl-5-hydroxymethylimidazole and the like; and compounds containing 2 or more imidazole rings per molecule which are obtained by dehydrating above-named hydroxymethyl-containing imidazole compounds such as 2-phenyl-4,5-dihydroxymethylimidazole, 2-phenyl-4-methyl-5-hydroxymethylimidazole and 2-phenyl-4-benzyl-5-hydroxy-methylimidazole; and condensing them with formaldehyde, e.g., 4,4′-methylene-bis-(2-ethyl-5-methylimidazole), and the like.

In other embodiments, suitable catalysts may include amine catalysts such as N-alkylmorpholines, N-alkylalkanolamines, N,N-dialkylcyclohexylamines, and alkylamines where the alkyl groups are methyl, ethyl, propyl, butyl and isomeric forms thereof, and heterocyclic amines.

In an embodiment, the components are admixed to form a curable composition. The components can be admixed in any combination or subcombination.

The compositions in the above-described embodiments can be used to produce varnishes. In addition to an epoxy resin, a varnish can also contain curing agents, hardeners, and catalysts. A varnish can then be used to produce a variety of products including but not limited to prepregs, electrical laminates, coatings, composites, castings and adhesives.

Embodiments of the present disclosure provide prepregs. The prepreg can be obtained by a process that includes impregnating a matrix component into a reinforcement component. The matrix component surrounds and/or supports the reinforcement component. The disclosed curable compositions/varnishes can be used for the matrix component. The matrix component and the reinforcement component of the prepreg provide a synergism. This synergism provides that the prepregs and/or products obtained by curing the prepregs have mechanical and/or physical properties that are unattainable with only the individual components.

The reinforcement component can be a fiber. Examples of fibers include, but are not limited to, glass, aramid, carbon, polyester, polyethylene, quartz, metal, ceramic, biomass, and combinations thereof. The fibers can be coated. An example of a fiber coating includes, but is not limited to, boron.

Impregnating the matrix component into the reinforcement component may be accomplished by a variety of processes. The prepreg can be formed by contacting the reinforcement component and the matrix component via rolling, dipping, spraying, or some other procedure. After the prepreg reinforcement component has been contacted with the prepreg matrix component, the solvent can be removed via volatilization. While and/or after the solvent is volatilized the prepreg matrix component can be cured, e.g. partially cured. This volatilization of the solvent and/or the partial curing can be referred to as B-staging. The B-staged product can be referred to as the prepreg. For some applications, B-staging can occur via an exposure to a temperature of 60° C. to 250° C.; for example B-staging can occur via an exposure to a temperature from 65° C. to 240° C. , or 70° C. to 230° C. For some applications, B-staging can occur for a period of time of 1 minute to 60 minutes; for example B-staging can occur for a period of time from, 2 minutes to 50 minutes, or 5 minutes to 40 minutes. However, for some applications the B-staging can occur at another temperature and/or another period of time.

One or more of the prepregs may be cured, e.g. more fully cured, to obtain a product. The prepregs can be layered or/and formed into a shape before being cured further. For some applications, e.g. when an electrical laminate is being produced, layers of the prepreg can be alternated with layers of a conductive material. An example of the conductive material includes, but is not limited to, copper foil. The prepreg layers can then be exposed to conditions so that the matrix component becomes more fully cured.

One example of a process for obtaining the more fully cured product is pressing. One or more prepregs may be placed into a press where it subjected to a curing force for a predetermined curing time interval to obtain the more fully cured product. The press may have a curing temperature of 80° C. to 250° C.; for example the press may have a curing temperature of 85° C. to 240° C., or 90° C. to 230° C. For one or more embodiments, the press has a curing temperature that is ramped from a lower curing temperature to a higher curing temperature over a ramp time interval.

During the pressing, the one or more prepregs can be subjected to a curing force via the press. The curing force may have a value that is 5 pounds per square inch (psi) to 50 psi; for example the curing force may have a value that is 10 psi to 45 psi, or 15 psi to 40 psi. The predetermined curing time interval may have a value that is 5 seconds(s) to 500 s; for example the predetermined curing time interval may have a value that is 25 s to 540 s, or 45 s to 520 s. For other processes for obtaining the product other curing temperatures, curing force values, and/or predetermined curing time intervals are possible. Additionally, the process may be repeated to further cure the prepreg and obtain the product.

### EXAMPLES

The tougheners shown in Table I below were evaluated in these examples.

TABLE I
Tougheners

| | | Particle size | % | Core | % |
|---|---|---|---|---|---|
| Material | Manufacturer | (μm) | Core | Composition | Shell |
| GRC-310 | Dow | 0.1/0.6 | 47 | Butadiene/ | 53 |
| | | bimodal | | Styrene 93/7 | |
| Kaneka CSR | Kaneka | 0.1 | | | |

The following resin formulations were evaluated:

### Example 1—D.E.R.™ 592/dicyandiamide (DICY)

### Example 2—XU19074 (oxazolidone-modified epoxy)/XZ92535 (phenol-novolac based hardener)

### Example 3—D.E.N.™ 438/XZ92535/D.E.R.™ 560

### Example 4—D.E.N.™ 438/XZ92535/D.E.R.™ 560/Kaneka CSR 4%

### Example 5—D.E.N.™ 438/XZ92535/D.E.R.™ 560/Kaneka CSR 8%

### Example 6—EBPAN/BPN/D.E.R.™ 560

### Example 7—D.E.N.™ 438/XZ92535/D.E.R.™ 560/DL955™

### Example 8—D.E.N.™ 438/Resicure 3026/D.E.R.™ 560/GRC-310

### Example 9—D.E.N.™ 438/Resicure 3026/D.E.R.™ 560

### Sample Preparation

The varnish components were blended in methyl ethyl ketone (MEK) and shaking until homogeneous. The GRC-310 toughener was predispersed in MEK at 20% solids level using a Cowles blade at 2000 rmp. The solids content of the final formulation was adjusted to obtain a viscosity of “B” using the Gardner bubble viscosity standards.

The reactivity of the varnish was measured using the Stroke cure test. A few grams of sample was placed on a hot plate at 171° C. and stroked using a wooden spatula. The elapsed time in seconds required for gelation, as indicated by a sudden increase in the viscosity, is the resin reactivity with a target of 260 seconds. Additional catalyst (2-methylimidazole) was added as needed to adjust the reactivity.

### Prepreg Preparation

The prepregs were prepared using a treater. A pan was filled with a formulation and a glass fiber mat was impregnated with resin by rolling it through the varnish. The impregnated glass cloth was then passed through 30 feet of heated oven space in a Litzler (Examples 8 and 9) or Caratsch (Examples 1-7) pilot treater. The oven temperature was 177° C. and the impregnated roll speed was 10 ft/min To determine the resin content, a 10″×10″ square sheet of glass cloth was weighed before and after the treater run according to methods IPC-L-109B and IPC-TM-650:2.3.16. The resin content is calculated as the pick up weight scaled by the original weight of the glass cloth. The prepregs were then evaluated for appearance, dust formation, and gel time. Evaluation of prepreg appearance was done by a visual inspection of prepreg surface and color. Laminates for Examples 8 and 9 were prepared using glass fiber 7628 (Hexcel) while the rest were prepared on glass fiber 7628 (Porcher).

To determine the gel time of the prepreg, powder was crushed off the prepreg. Care was taken to ensure that there were no glass fibers in the powder. About 0.25 grams of prepreg powder was placed on a hotplate at 171° C. and stroked using a wooden spatula. The gel time was recorded as the elapsed time required for gelation. Typical prepreg gel times were about 90 seconds.

### Laminate Fabrication

Fabrication of laminates was performed by sandwiching 12″×12″ sheets of prepreg between two stainless steel plates, inserted into a hydraulic press and ramped at 6° C./min to 190° C. The hydraulic press was held for 90 minutes at ˜110-111 psi. Similarly, copper clad laminates were prepared by sandwiching the sheets of prepreg between two sheets of copper foil. Thermomechanical properties were performed according to the evaluations described below.

### Glass Transition Temperature

The glass transition temperature was measured by differential scanning calorimetry (DSC) on a dual cell TA Instruments 2920. Approximately 10 mg of sample were subjected to two consecutive temperature ramps at 10° C./min from ambient temperature to 250° C. Exothermic activity on the first scan was closely followed to ensure full cure. The sample was then subjected to a third ramp at 20° C./min and Tg was determined using the inflection point. Therefore, the laminate experiences additional cure in the DSC evaluation that it did not receive before the physical property testing.

### Decomposition Temperature

A Thermal Gravimetric Analyzer (TGA), TA Instruments Q50, was used to determine the decomposition temperature (Td) of the samples. Td is determined as the temperature at which the sample experiences a 5% weight loss. About 25 mg of sample are ramped at a rate of 10° C./min to 600° C. The Td is measured using a three-line step transition analysis. TGA is also used to evaluate residue percentage or char yield. Final residue percentage is taken at 550° C.

### Thermal Expansion

A Thermal Mechanical Analyzer (TMA), TA Instruments Q400, was used to measure the coefficient of linear thermal expansion (CLTE) below and above Tg. Copper clad laminate samples are cut into ˜9 mm×9 mm squares using a water cooled diamond tile saw. CLTE (<Tg and >Tg) is obtained from the slope of the thermogram below and above Tg. The TMA was also used to determine the time to delamination at 288° C. (T288). The time to delamination was determined as the elapsed time from when the temperature reached 288° C. to when a sudden significant dimensional change (˜100 mm) occurred.

### Interlaminar Fracture Toughness

The standard dual cantilever beam geometry in Mode 1 was used to evaluate interlaminar toughness using the ASTM standard D-5528. Samples were prepared from double-thick 16-ply unclad laminates to enhance the bending stiffness. A crack initiator for the fracture test was facilitated by a thin sheet of Mylar that was inserted from one edge (about 2.5 inches) in the middle of the lay-up during stacking of the prepregs prior to consolidation. After consolidating and curing the laminate in the press, a wet circular saw was used to cut test specimens that were approximately 1 inch wide and 7 inches long. Metallic blocks were glued to the primed specimens using a two-part Plexus methacrylate adhesive. The blocks were held to the specimens using a C-clamp and allowed to sit overnight for the adhesive to cure. For the fracture test, the samples were gripped on an MTS 810 servo-hydraulic test frame using hinges that accommodated the blocks. A dowel pin was used to hold the specimen in place during the experiment. The samples were loaded at a fixed rate of 0.2 in/min and during the test, both load and stoke signals were recorded using a computer controlled data acquisition system. Samples were loaded until the total crack length reached 45 mm.

### Copper Peel

Copper peel was measured using an IMASS SP-2000 slip/peel tester equipped with a variable angle peel fixture capable of maintaining the desired 90° peel angle throughout the test. For the copper etching, 2″×4″ copper clad laminates were cut. Two strips of ¼″ graphite tape were placed lengthwise along the sample on both faces of the laminate with at least a ½″ space between them. The laminate pieces were then placed in a KeyPro bench top etcher. Once the samples were removed from the etcher and properly dried, the graphite tape was removed to reveal the copper strips. A razor blade was used to pull up ½ of each copper strip. The laminate was then loaded onto the IMASS tester. The copper strip was clamped and the copper peel test was conducted at a 90° angle with a pull rate of 2.8 in/min.

### Punch Damage

A motorized puncher was used to evaluate the laminate delamination subsequent to a slow punching force. The punch test was performed by inserting the laminate between the hemispherical indenter and the cup. The hexagonal plain head of the screw was installed in the socket fixed to a high torque motor. A flag can be aligned to the top arrow indicator to indicate when to stop the machine after two complete rotations in about 5.4 seconds. After the specimens are punched the diameter of the delamination area around the point of contact is measured using calipers with the aid of a backlight to illuminate the damaged laminate.

TABLE II
Thermomechanical Properties

| Resin | % Resin Content | Thickness (mm) | Tg (° C.) |
|---|---|---|---|
| Example 1 | 49.2 | 1.75 | 179.3 |
| Example 2 | 43.6 | 1.56 | 176.9 |
| Example 3 | 42.6 | 1.45 | 164.9 |
| Example 4 | 43.1 | 1.54 | 168.3 |
| Example 5 | 46.2 | 1.53 | 168.4 |
| Example 6 | 39.1 | 1.45 | 199.6 |
| Example 7 | 41.5 | 1.47 | 167.7 |
| Example 8 | 42.7 | 1.57 | 175.8 |
| Example 9 | 45.6 | 1.65 | 176.6 |

TABLE III
Thermomechanical Properties

| | | | % Moisture | % Solder Dip |
|---|---|---|---|---|
| Resin | Td (5% loss) | Copper Peel | Uptake | Pass |
| Example 1 | 296 | 10.3 | 0.42 | 100 |
| Example 2 | 315 | 7.3 | 0.4 | 30 |
| Example 3 | 359 | 7.1 | 0.26 | 100 |
| Example 4 | 357 | 6.7 | 0.23 | 100 |
| Example 5 | 353 | 7.8 | 0.3 | 100 |
| Example 6 | 363 | 6.1 | 0.27 | 100 |
| Example 7 | 357 | 6.5 | 0.22 | 70 |
| Example 8 | 361 | 7.1 | 0.35 | 100 |
| Example 9 | 365 | 7.3 | 0.25 | 90 |

TABLE IV
Thermomechanical Properties

| | CTE < Tg | CTE > Tg | T288 | G1C |
|---|---|---|---|---|
| Resin | (ppm) | (ppm) | (min) | (kJ/min) |
| Example 1 | 62.3 | 300.3 | 0.2 | 0.63 |
| Example 2 | 53.7 | 228.4 | 3 | 1.1 |
| Example 3 | 59.1 | 221.5 | >30 | 0.36 |
| Example 4 | 67.4 | 265.8 | 27.2 | 0.57 |
| Example 5 | 67.7 | 272.7 | 28.5 | 0.2 |
| Example 6 | 47 | 184 | >30 | 0.14 |
| Example 7 | 64.1 | 273.6 | 22.5 | 0.43 |
| Example 8 | 50.1 | 203.6 | >30 | 0.63 |
| Example 9 | 50.6 | 229.5 | >30 | 0.43 |

As is evident from the above tables, the GRC-310 toughened formulation (Example 8) exhibits a good balance of all the thermomechanical metrics.

1. A composition comprising:
an epoxy resin;
a curing agent; and
a bimodal core shell rubber comprising a styrene butadiene core and a styrene-acrylonitrile shell.

2. A composition in accordance with claim 1 wherein said bimodal core shell rubber is prepared by a process comprising:
a) preparing an aqueous emulsion of an elastomeric polymer, wherein particles of said elastomeric polymer comprise an elastomeric conjugated diene polymer and have a volume average particle size of from 0.15 to 0.22 microns; and
b) agglomerating said aqueous emulsion such that from 5 to 50 weight percent of said particles are agglomerated.

3. The composition of claim 1, wherein the composition comprises from 0.1 weight percent to 30 weight percent bimodal core shell rubber, based on a total weight of the curable composition.

4. The composition of claim 1, further comprising a hardener.

5. The composition of claim 1, wherein the epoxy resin comprises at least one brominated epoxy resin.

6. A varnish produced from the composition of claim 1.

7. An electrical laminate prepared from the varnish of claim 6.

8. A circuit board prepared from the varnish of claim 6.

9. A coating prepared from the varnish of claim 6.

10. A composite prepared from the varnish of claim 6.

11. A casting prepared from the varnish of claim 6.

12. An adhesive prepared from the varnish of claim 6.
